(19) United States
(12) Patent Application Publication
(10) Pub. No.: US 2012/0096407 A1
(43) Pub. Date: Apr. 19, 2012

(54) VISUALIZATION METHOD FOR PARTIAL VIEWING OF DECISION TREE INFORMATION

(76) Inventor: JOHN LEWIS, II, Glen Allen, VA (US)

(21) Appl. No.: 13/273,634

(22) Filed: Oct. 14, 2011

Related U.S. Application Data
(60) Provisional application No. 61/394,446, filed on Oct. 19, 2010.

(51) Int. Cl. G06F 3/048

(52) U.S. Cl. 715/841

(57) ABSTRACT

Instead of the “all or nothing” prior art approaches of using decision trees or document prose, embodiments of the invention may provide a visualization method of viewing specific branches of a decision tree, to visualize “consequential” knowledge, which represent one particular thought process. Embodiments of the invention enable the creation of an Option Outline (which may also be termed a “consequential knowledge outline”) which allows for the visualization and manipulation of multiple “trails of thought” which provides context to previous decisions, transparency into the thought process of predicted outcomes or decisions, voting on choices, and a visual method of conflict resolution.

### CROSS-REFERENCE TO RELATED APPLICATIONS

This application claims priority to provisional U.S. Application No. 61/394,446, filed Oct. 19, 2010, the contents of which are incorporated herein by reference in their entirety.

### FIELD OF THE INVENTION

The present relates to information and decision visualization.

### BACKGROUND

Decisions are made daily at every level within an organization, presumably within the context of some understanding of prior decisions. With the expectation of collaborative decision making, and the limited time that decision-makers have to make decisions, there remains less time to read through pages of documents to understand prior decisions.

In addition to time pressures to make decisions, the complexity of the decisions and the impact implications continue to mount. And then after making a decision, there is more demand for transparency into the decision making process.

Currently there are tools that help us answer the basic question of “which” when making a single decision, for example, by using a prioritization matrix with weighted importance assigned to specific requirements. And software exists to aid us when the number of variables going into a single decision reaches into the hundreds.

But currently there are few tools that help us answer the basic question of “why” when asking to see, in one snapshot, the prior options and decisions that have led to the current situation. Projects end with choices made that were either not captured, or were buried somewhere within the prose of many documents. When an organized approach is attempted, we begin to see the structure of a decision tree, which lists all of the possible options and choices, instead of just the ones considered and needed at the time. But requiring “all” possible options to be documented has resulting in capturing none of them within some structured view of the thought process. Embodiments of the invention address this “all of nothing” problem with managing consequential knowledge.

### BRIEF SUMMARY

In one embodiment of the invention, a computer-implemented method for creating a consequential knowledge outline comprises (a) receiving user input of a plurality of possible choices at a top level of a decision process; (b) receiving user input of a selected choice at the top level of the decision process, the selected choice comprising one of the possible choices; (c) displaying the top level possible choices in a linear arrangement with the top level selected choice displayed last in the linear arrangement; (d) receiving user input of a plurality of possible choices at a next lower level of the decision process which are dependent on the selected choice at the prior level; (e) receiving user input of a selected choice at the next lower level of the decision process, the selected choice comprising one of the possible choices; (f) displaying the next lower level possible choices in a linear arrangement with the next lower level selected choice displayed last in the linear arrangement, wherein the linear arrangement is indented from the linear arrangement of the prior level; and (g) repeating steps (d)-(f) for each subsequent lower level of the decision process.

The method may further comprise storing all of the received user inputs of possible choices for all levels of the decision process; storing all of the received user inputs of selected choices for all levels of the decision process; and determining and storing all relationships and dependencies among the received user inputs of possible choices for each level and the received user inputs of selected choices for each prior level of the decision process.

The method may further comprise receiving user input of a different selected choice at one level; modifying the display such that the different selected choice is displayed last in the linear arrangement of possible choices at the one level; and modifying the display such that the possible choices which are dependent on the previously selected choice at the one level are not displayed.

The method may further comprise determining if there are any stored possible choices, at the next lower level from the one level having the different selected choice, which are dependent on the different selected choice; and if so, modifying the display such that the determined possible choices which are dependent on the different selected choice are displayed in a linear arrangement indented from the linear arrangement of the one level.

The method may further comprise, if it is determined that there are not any stored possible choices, at the next lower level from the one level having the different selected choice, which are dependent on the different selected choice, then prompting the user to input one or more possible choices that are dependent on the different selected choice.

The method may further comprise prompting a user to provide input indicating either (i) agreement or disagreement or (ii) a degree of agreement corresponding to each group of possible choices displayed at each of one or more levels.

The method may further comprise prompting a user to provide input indicating either (i) agreement or disagreement or (ii) a degree of agreement corresponding to each possible choice displayed at each of one or more levels.

The linear arrangements may comprise a top-to-bottom vertical arrangement.

In addition to the method for creating a consequential knowledge outline, other aspects of the present invention are directed to corresponding systems and computer program products for creating a consequential knowledge outline.

In another embodiment of the invention, a computer-implemented method for modifying a display of a decision tree comprises (a) determining all possible choices at a top level of the decision tree; (b) determining a selected choice at the top level of the decision tree, the selected choice comprising one of the determined possible choices; (c) displaying the determined top level possible choices in a linear arrangement with the determined top level selected choice displayed last in the linear arrangement; (d) determining all possible choices at a next lower level of the decision tree based on the determined selected choice at the prior level, wherein the possible choices at the next lower level do not include choices dependent on non-selected choices at the prior level; (e) determining a selected choice at the next lower level of the decision tree, the selected choice comprising one of the determined possible choices; (f) displaying the determined next lower level possible choices in a linear arrangement with the determined next lower level selected choice displayed last in the linear arrangement, wherein the linear arrangement is indented from the linear arrangement of the prior level; and (g) repeating steps (d)-(f) for each subsequent lower level of the decision tree.

The linear arrangements may comprise a top-to-bottom vertical arrangement.

In addition to the method for modifying a display of a decision tree, other aspects of the present invention are directed to corresponding systems and computer program products for modifying a display of a decision tree.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a representation of a typical prior art decision tree diagram.

FIG. 2 is a representation of an option outline, in accordance with embodiments of the invention.

FIG. 3 is a basic example of an option outline, in accordance with embodiments of the invention.

FIG. 4 is an example of change from FIG. 3.

FIG. 5 is an example of an option outline which provides for linkage to other content, including reference material, in accordance with embodiments of the invention.

FIG. 6 is an example of an option outline being used for voting, in accordance with embodiments of the invention.

FIG. 7 is an example of an option outline being used for predicted outcomes, in accordance with embodiments of the invention.

FIG. 8 is an example of an option outline being used for decision logic, with embedded steps to be performed, in accordance with embodiments of the invention.

FIG. 9 is an example of an option outline showing a collapsed view of a branch, in accordance with embodiments of the invention.

FIG. 10 is a schematic block diagram of a computer network in which embodiments of the present invention may operate.

FIG. 11 is a schematic block diagram of a computer in the network of FIG. 10.

### DETAILED DESCRIPTION

Instead of the “all or nothing” prior art approaches of using decision trees or document prose, embodiments of the invention may provide a visualization method of viewing specific branches of a decision tree, to visualize “consequential” knowledge, which represent one particular thought process. Embodiments of the invention enable the creation of an Option Outline (which may also be termed a “consequential knowledge outline”) which allows for the visualization and manipulation of multiple “trails of thought” which provides context to previous decisions, transparency into the thought process of predicted outcomes or decisions, voting on choices, and a visual method of conflict resolution.

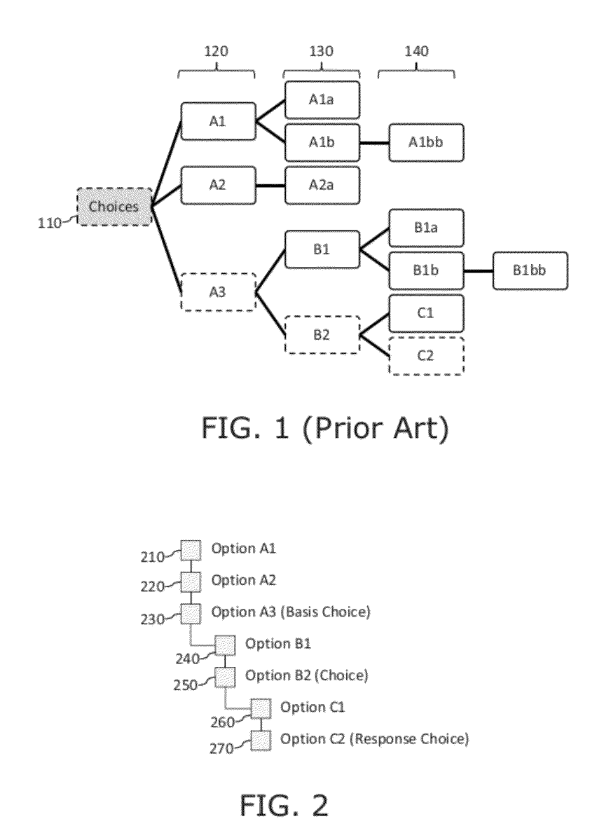

FIG. 1 is a representation of a typical prior art decision tree diagram, where choices from the options at the highest level present new options at the next level to choose from. For purposes of comparison to the invention and FIG. 2, the diagram of FIG. 1 highlights a particular branch chosen of A3, B2, and C2 (the selection of A3, B2 and C2 are illustrated by the dashed lines of those boxes). A decision tree diagram starts at the trunk of the tree, at 110, and then to the first level of branches, at 120. Each of those branches may then have additional branches, at 130, and likewise they could have more branches, at 140. A decision tree diagram may have fewer or a greater number of levels than the three levels illustrated in FIG. 1. Choices made closer to the trunk of the tree have implications for further choices, as options change based on previous decisions. For example, the choice of A3 at level 120 precludes the choice of A1a, A1b, of A2a at level 130. This representation of consequential knowledge is difficult for users to manage since it has to represent an entire tree of options, and requires graphics with boxes and lines to represent. Currently people normally discuss, but do not visualize, consequential knowledge, using a simple “Question/Answer” framework, where answers are taken out of context from the decision tree, since most people do not create decision tree diagrams to illustrate their train of thought.

FIG. 2 is a representation an Option Outline of embodiments of the invention, where instead of providing a visualization of the entire decision tree, only the chosen branches are displayed. FIG. 2 illustrates an Option Outline of the decision tree diagram of FIG. 1, providing an alternative method of illustrating the choice of A3, B2, C2 and the decision points at each level that lead to the choice of A3, B2, C2. By reading from top to bottom, we see the options that were available/selectable at each level, with the selected option listed last, for each indentation within the Option Outline. While this “down/right” display (that is, the Option Outline is read top down, left to right) is typically a preferred method of this invention to visualize chosen braches from an entire tree of options, due to a standard HTML browser's innate ability to scroll down and right when the content is larger than the browser window, other embodiments of this invention could be viewed in other directions, including but not limited to down and left, up and right, and up and left. At 210, 220, and 230, we see the basis or fundamental (i.e., top level) options. Option A3 is displayed last (i.e., at the bottom of the three possible choices—A1, A2 and A3—in this down and right Option Outline) because option A3 is the selected option (as illustrated by the dashed line of block A3 in level 120 of FIG. 1). The selection at this first level may be termed the “Basis Choice.” At 240 and 250, we see the two selectable options at the next level (i.e., level 130 of FIG. 1), with option B2 displayed last because option B2 is the selected option (as illustrated by the dashed line of block A2 in level 130 of FIGS. 1). At 260 and 270, we see the two selectable options at the last (bottom) level (i.e., level 140 of FIG. 1), with option C2 displayed last because option C2 is the selected option (as illustrated by the dashed line of block C2 in level 140 of FIG. 1). The selection at this last level may be termed the “Response Choice,” as this choice reflects the ultimate decision. Each of the selections at each level between the first and last levels (there being only one such level illustrated in FIG. 2) may simply be termed a “Choice.”

Importantly, as selections made at each level have precluded the selection of particular other options/branches, those precluded options/branches are not illustrated in the Option Outline. As an example, the selection of A3 (and not A1 or A2) has precluded the selection of A1a or A1b (because A1a and A1b are only available if A1 is selected) and has precluded the selection of A2a (because A2a is only available if A2 is selected). As such, A1a, A1b and A2a are not illustrated in the Option Outline, nor are any options “downstream” of A1a, A1b or A2a (i.e., A1bb, B1a, B1b, B1bb) illustrated. This combination of displaying last the selected option at each level, and not displaying the options/branches which were not even considered due to choices made at higher levels, provides a simpler, easier-to-understand representation of the decision process.

An option outline is typically created by one of two methods: by a database, or by a user. When an option outline is created by a database, the contents of a decision tree (i.e., the options at each level, the dependencies between levels, and optionally the option selected at each level, as illustrated, for example, in FIG. 1) may be used to produce a visualization of that decision tree that represents a chosen branch of that tree (for example, FIG. 2). An option outline illustrating a particular branch of a decision tree might be created step-by-step, such as by prompting a user for a selection to be made for each level (for example, first prompt a user to select either A1, A2 or A3 of FIG. 1 at 120, then prompt to select one of the options dependent on the preceding selected option, etc.). Such a step-by-step approach may be desirable when the decision tree does not contain information regarding the final choices at each level, or if the user desires to create an option outline illustrating different branches other than that dictated by the final choices.

Alternatively, an entire branch could be presented all at once, based on a variable stored about that decision tree and that user. For example, FIG. 2 is an entire branch being presented from FIG. 1 based on seeing the final choice of A3-B2-C2. But an option outline could be based on different option selections at each level (not necessarily the final choice). For example, an option outline might be created to enable seeing a dissenting opinion, if reviewing court cases for example, or be based on seeing a particular user's branch of thought. This would be helpful in conflict resolution by switching between branches to see where trains of thought begin to diverge. It may also be desirable to create one or more option outlines based on randomly selected choices at each level, thereby creating many different possible branches. Such multiple, randomly created option outlines may be desirable, for example, for polling to enable different poll participants to opine about different decision tree branches.

When an option outline is created directly by a user (i.e., not from a decision tree), the user would typically not need to see the decision tree (for example, FIG. 1) since they would be working with the option outline representation directly (for example, FIG. 2). The task would be similar to using a bulleted or numbered list in a word processing program. But typical bulleted lists represent contextual knowledge, showing ideas that go together. And typical numbered lists represent sequential knowledge, showing a linear order of ideas. In contrast, option outlines of embodiments of the invention represent consequential knowledge, showing options with a choice which leads to the next set of consequential options. For example, a chess player could list all of the options possible for the first move in a chess game (for example, FIG. 2 at 210, 220, 230, etc.). The last option listed would be the option the chess player decided to use for their first move. The user could also store notes and reference content with this last option describing, for example, why that move was chosen, and what the opponent's next move was based on this choice. Now the chess player would indent under that chosen move and list all of the options possible for their second move in the chess game (for example, FIG. 2 at 240, 250, etc.). Again, the last option listed would be the option the chess player decided to use for their second move. And this pattern repeats for the entire game, with, in this case of a chess game, the list of options within each indentation reducing over the course of the game. Note that since the option outline is being created by the user, not by the database, the user does not need to see the entries being made in the decision tree representation (for example, FIG. 1). The option outline being created by the user may be saved in a database. Saving the option outline will typically involve saving the data (i.e., the options at each level and the selected choice at each level) and relationships (e.g., which options are dependent on which other options at other levels) underlying the option outline into a database. The option outline may be saved automatically (e.g., at regular specified intervals) and/or may be saved in response to the user instructing the system to save the option outline.

To continue this example of a chess game, imagine after the chess match that the chess player's coach wanted to view the match and create notes and an alternative ending. As the coach initially opens the option outline, it is being created by the database (based on the options choices, dependencies, and selections at each level that were stored in the database as described above based on the user-created option outline), based on the moves that lead to the final move. But then the coach (user) could add notes for any option, but also change the position of an option to be last within an indentation, making it the chosen option, with notes on probable opponent moves, and create an alternative ending. Such a modification of the option outline might correspondingly modify the original data in the database, or the user might be prompted to save the new data (new options, new selections, new dependencies) as a new dataset, thereby allowing either the original option outline or the new revised option outline to be viewed at will. Now the original chess player can open the option outline for the game and have it created by the database to represent their original option outline or the branch representing their coach's input. This example of creating an option outline by a user to capture their options and choices for a chess game is intended as an extreme example, with many options listed and many indentations, to present a familiar scenario of consequential knowledge where a choice leads consequentially to a different set of options, and to demonstrate that the option outline could be used in an extremely large scenario. However, most personal, project, policy, etc. scenarios would probably not be this extreme.

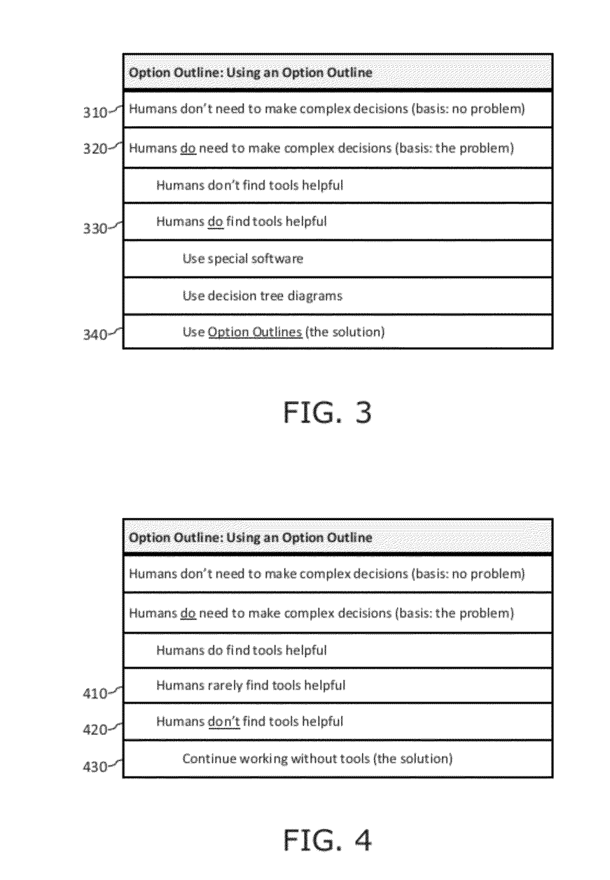

FIG. 3 is a basic example of an option outline, in accordance with embodiments of the invention, where the example “thought process” is related to the invention itself. Reading from the top, the basis provides the “going-in” assumptions that either humans do (320) or do not (310) need to make complex decisions. Between these two options, the chosen option is that humans do need to make complex decisions (320). The visualization method of embodiments of the invention represents this as the choice since it is listed last within that particular level of indentation. That takes us to the question as to whether humans find tools to be helpful, and the chosen option listed last, is that humans do find tools to be helpful (330). Given this decision, we see the next indentation with options related to which tools to use, and the decision to use Option Outlines (340) is listed last, showing it is the choice within the list of options at that level of indentation.

FIG. 4 is an example of how the Option Outline of FIG. 3 might be changed, such as by adding, deleting, or changing selectable options and/or by changing which options have been selected. Specifically, at 410 a new option has been inserted, at 420 an existing option has been moved (i.e., to reflect that 420 is now the selected option at that level, 420 is now the last option on that level), and at 430 a new option appears (assuming previously inserted) in relationship to the selection at 420. Note that the three options under 330 in FIG. 3 are no longer shown in FIG. 4 because 330 is no longer the selected option at that level in FIG. 4. Moving options within the outline is accomplished with a number of methods, not limited to but including, drag-and-drop and up-and-down arrows associated with a selected row. By changing the options listed as the last within a particular indentation, the view changes to present that new branch from the decision tree. Other standard database manipulations are also possible as well, including, deleting, inserting, moving, and modifying an existing item, for example, name change, reference properties, etc.

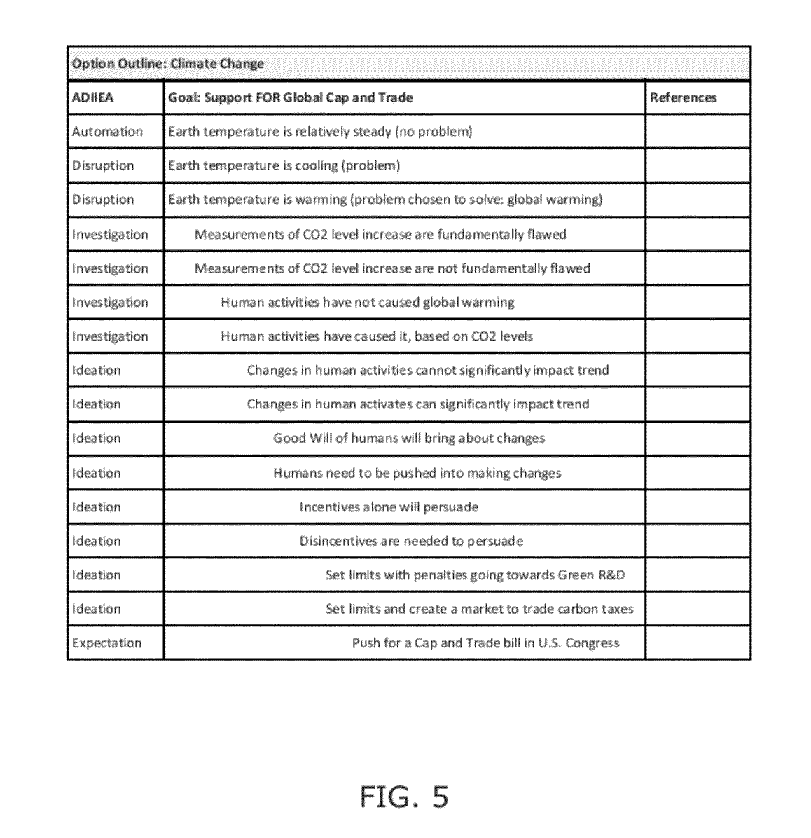

FIG. 5 is an example of an option outline in accordance with embodiments of the invention which provides for linkage to other content, including reference material and an indication of the phase within a change management method where the options are being considered. In this example, the reference model is ADIIEA (Automation, Disruption, Investigation, Ideation, Expectation, Affirmation) (as detailed in U.S. Provisional Application No. 61/394,446, filed Oct. 19, 2010), but other popular models could be used as well, for example DMAIC (Define, Measure, Analyze, Improve, Control) or ADDIE (Analysis, Design, Develop, Implement, Evaluate) or CLICK (Components, Links, Implementation, Composite, Knack) (as detailed in U.S. Provisional Application No. 61/394,446, filed Oct. 19, 2010). While this embodiment shows how related and reference content for each option can be visually presented next to each option, other embodiments are possible, especially when using smaller screen sizes, where, for example, related and reference content can be made available by clicking on each option to produce a menu of actions possible. Such reference content may be, for example, detailed information, background, prior decisions (precedent), arguments for, arguments against, evidence, sources, or even another option outline.

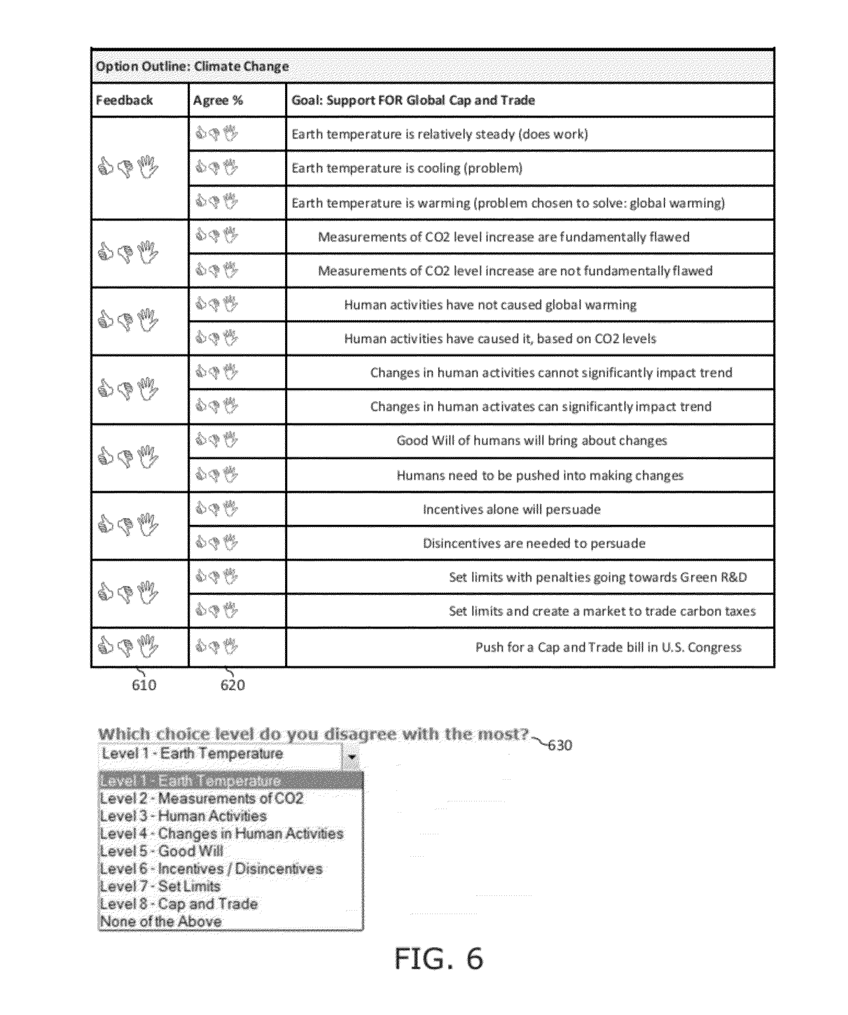

FIG. 6 is an example of an option outline in accordance with embodiments of the invention being used for voting. Such an option outline may enable one to see where there is the most agreement and disagreement throughout the thought process, rather than seeking opinions for choices taken out of context from their thought process, which is the current practice of polling. At 610, this embodiment allows for feedback for an entire group of options, based on each level of indentation. At 620, feedback can also be provided specifically for each option. This embodiment shows a “thumbs up” icon to click for indicating agreement, but other icons could be used. This embodiment shows a “thumbs down” icon to click for indicating disagreement, but other icons could be used. This embodiment shows a “wait hand” icon to click for indicating you would like to enter a comment, reference, new option, etc., but other icons could be used. In addition to allowing for agreement and disagreement for each option in the thought process of the Option Outline, at 630 a menu of choices representing each indentation level is provided to select an overall level that one disagrees with the most. This visualization provides the poll taker with the context from which solutions are chosen, and provides the poll creator with the location within the thought process that most people disagree, giving them both more information than the current single-question polls provide, taken out of context of any thought process.

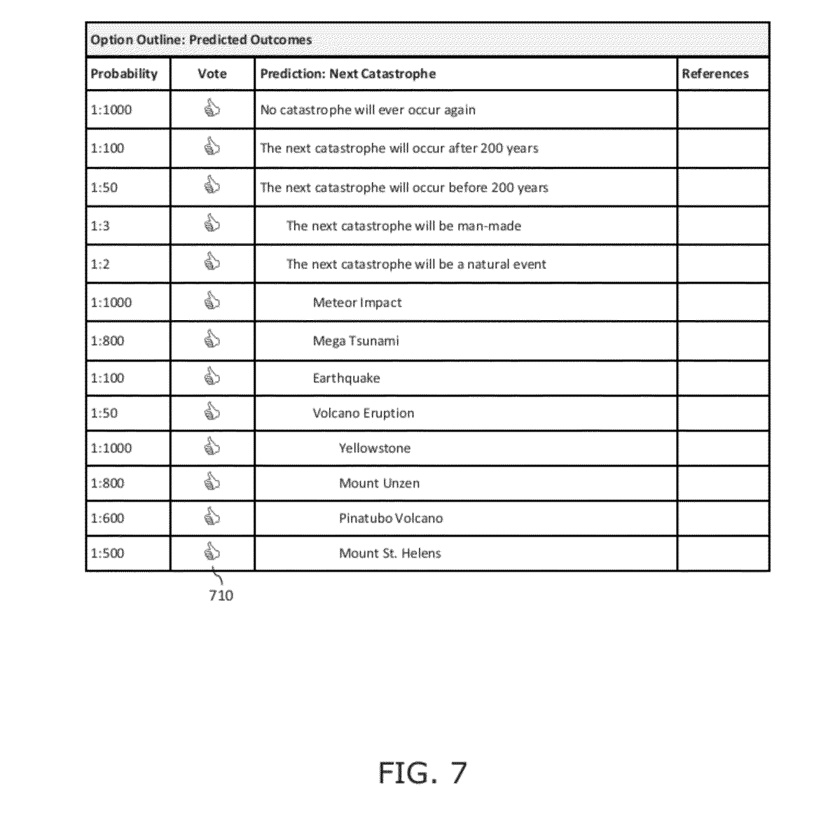

FIG. 7 is an example of an option outline of embodiments of the invention being used for predicted outcomes, where probability assumptions could be placed next to each entry, to visualize either decisions or chains of events. In this example, probabilities could be presented for each event, based on the research of the person or team that created this view of the thought process, or optionally, at 710, based on the votes that are tallied in the belief of a population for the likelihood of an event to occur. The same pattern for reading and modifying the Option Outline is represented, since the same underlying decision tree database system could be used. This embodiment simply shows additional uses of the invention's ability to represent consequential knowledge.

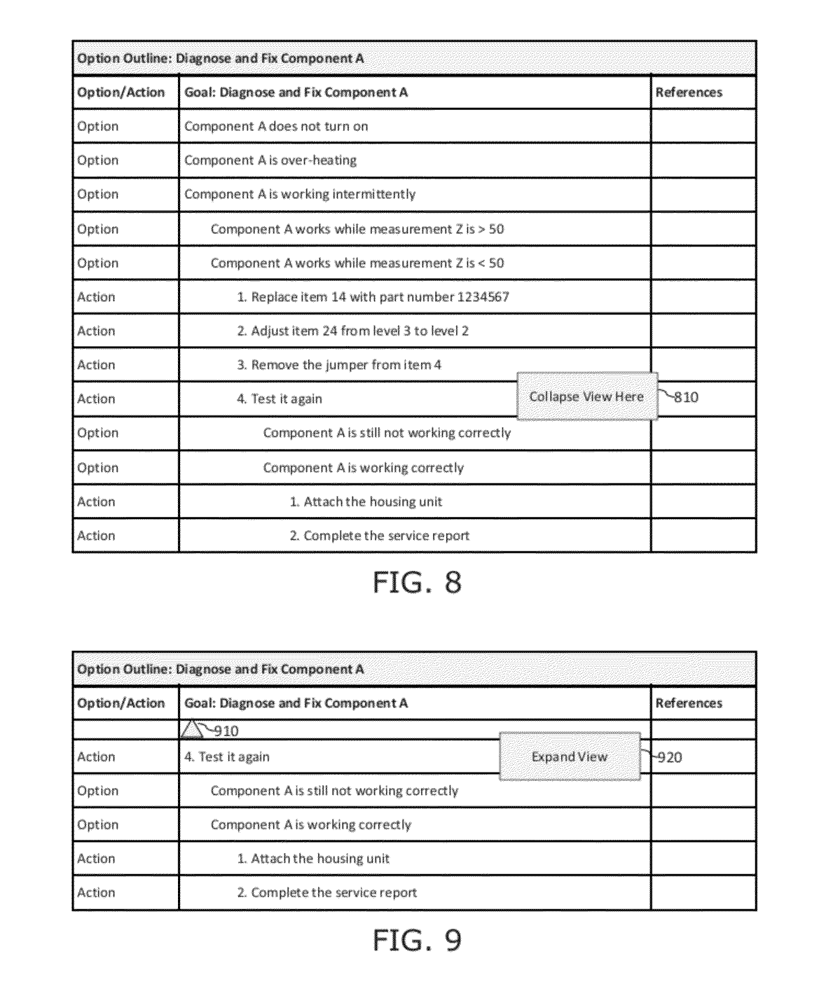

FIG. 8 is an example of an option outline of embodiments of the invention being used for decision logic, with embedded steps to be performed. The standard task for a general worker involves mainly steps, for which the visualization already exists within a task list with numbered steps. But most jobs now require “knowledge” workers, where there are more decision steps to perform along with any action steps. This embodiment shows an example of embedding “Action” steps in with the “Option” steps of the Option Outline. In addition, at 810, this embodiment represents the ability to collapse lengthy Option Outlines, which is advantageous for long Option Outlines and/or small display devices. Several collapsed views could exist, including starting the option outline at a particular point, or showing only the choices. The method of user interaction for collapsing the view in this embodiment at 810 is a pop-up menu for each line item; however other UI methods could be used.

FIG. 9 is an example of an option outline of embodiments of the invention showing a collapsed view of a branch. At 910 there is a visual indication in the user interface indicating that the current view is a collapsed view; however other UI methods could be used. At 920, there is a method of user interaction for expanding the view, using a pop-up menu; however other UI methods could be used.

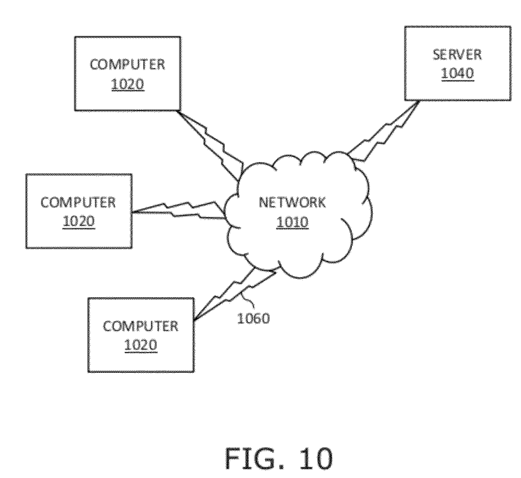

FIG. 10 is a schematic block diagram of a computer network in which embodiments of the present invention may operate. Computers 1020 and server 1040 provide processing, storage, and input/output devices executing application programs and the like. Computers 1020 may be linked over communication link 1060 through communications network 1010 to each other and to other computing devices, including servers 1040. Communications network 1010 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 1020 and servers 1040 may be linked over any suitable communication network.

In addition to the client-server arrangement of FIG. 10, embodiments of the invention may operate in any client-server arrangement or in any networked arrangement in which resources that originate communications and resources that receive communications may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates. Or additionally, embodiments of the invention may operate entirely within a single device (computer, tablet, mobile smart phone, etc).

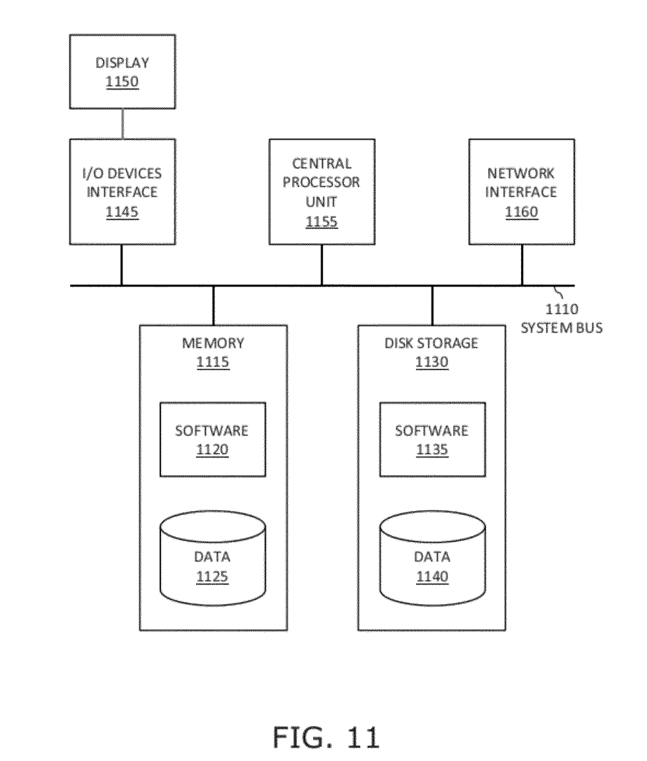

FIG. 11 is a diagram of one possible internal structure of a computer (e.g., computer 1020) or server (e.g., server 1040) in the system of FIG. 10. Each computer typically contains system bus 1110, where a bus is a set of hardware lines used for data transfer among the components of a computer. Bus 1110 is essentially a shared conduit that connects different elements of a computer system (e.g., processor, disk storage, memory, input/output ports, network ports, etc.) that enables the transfer of information between the elements. Attached to system bus 1110 is I/O device interface 1145 for connecting various input and output devices (e.g., displays 1150, printers, speakers, microphones, etc.) to the computer. Alternatively, the I/O devices may be connected via one or more I/O processors attached to system bus 1110. Network interface 1160 allows the computer to connect to various other devices attached to a network (e.g., network 1010 of FIG. 10). Memory 1115 provides volatile storage for computer software instructions 1120 and data 1125 used to implement an embodiment of the present invention. Disk storage 1130 provides non-volatile storage for computer software instructions 1135 and data 1140 used to implement an embodiment of the present invention. Central processor unit 1155 is also attached to system bus 1110 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Example implementations could be a stand-alone application for support of decision-making and transparency, or for voting, or to be embedded within a larger application for purposes such as decision support or project management.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A computer-implemented method for creating a consequential knowledge outline, comprising:
(a) receiving user input of a plurality of possible choices at a top level of a decision process;
(b) receiving user input of a selected choice at the top level of the decision process, the selected choice comprising one of the possible choices;
(c) displaying the top level possible choices in a linear arrangement with the top level selected choice displayed last in the linear arrangement;
(d) receiving user input of a plurality of possible choices at a next lower level of the decision process which are dependent on the selected choice at the prior level;
(e) receiving user input of a selected choice at the next lower level of the decision process, the selected choice comprising one of the possible choices;
(f) displaying the next lower level possible choices in a linear arrangement with the next lower level selected choice displayed last in the linear arrangement, wherein the linear arrangement is indented from the linear arrangement of the prior level; and
(g) repeating steps (d)-(f) for each subsequent lower level of the decision process.

2. The method of claim 1, further comprising:
storing all of the received user inputs of possible choices for all levels of the decision process;
storing all of the received user inputs of selected choices for all levels of the decision process; and
determining and storing all relationships and dependencies among the received user inputs of possible choices for each level and the received user inputs of selected choices for each prior level of the decision process.

3. The method of claim 1, further comprising:
receiving user input of a different selected choice at one level;
modifying the display such that the different selected choice is displayed last in the linear arrangement of possible choices at the one level; and
modifying the display such that the possible choices which are dependent on the previously selected choice at the one level are not displayed.

4. The method of claim 3, further comprising:
determining if there are any stored possible choices, at the next lower level from the one level having the different selected choice, which are dependent on the different selected choice; and
if so, modifying the display such that the determined possible choices which are dependent on the different selected choice are displayed in a linear arrangement indented from the linear arrangement of the one level.

5. The method of claim 4, further comprising:
if it is determined that there are not any stored possible choices, at the next lower level from the one level having the different selected choice, which are dependent on the different selected choice, then prompting the user to input one or more possible choices that are dependent on the different selected choice.

6. The method of claim 1, further comprising:
prompting a user to provide input indicating either (i) agreement or disagreement or (ii) a degree of agreement corresponding to each group of possible choices displayed at each of one or more levels.

7. The method of claim 1, further comprising:
prompting a user to provide input indicating either (i) agreement or disagreement or (ii) a degree of agreement corresponding to each possible choice displayed at each of one or more levels.

8. The method of claim 1, wherein the linear arrangements comprise a top-to-bottom vertical arrangement.

9. A computer program product for creating a consequential knowledge outline, the computer program product comprising a computer readable storage medium having computer readable program code embodied therewith, the computer readable program code comprising:
(a) computer readable program code configured for receiving user input of a plurality of possible choices at a top level of a decision process;
(b) computer readable program code configured for receiving user input of a selected choice at the top level of the decision process, the selected choice comprising one of the possible choices;
(c) computer readable program code configured for displaying the top level possible choices in a linear arrangement with the top level selected choice displayed last in the linear arrangement;
(d) computer readable program code configured for receiving user input of a plurality of possible choices at a next lower level of the decision process which are dependent on the selected choice at the prior level;
(e) computer readable program code configured for receiving user input of a selected choice at the next lower level of the decision process, the selected choice comprising one of the possible choices;
(f) computer readable program code configured for displaying the next lower level possible choices in a linear arrangement with the next lower level selected choice displayed last in the linear arrangement, wherein the linear arrangement is indented from the linear arrangement of the prior level; and
(g) computer readable program code configured for repeating steps (d)-(f) for each subsequent lower level of the decision process.

10. The computer program product of claim 9, further comprising:
computer readable program code configured for storing all of the received user inputs of possible choices for all levels of the decision process;
computer readable program code configured for storing all of the received user inputs of selected choices for all levels of the decision process; and
computer readable program code configured for determining and storing all relationships and dependencies among the received user inputs of possible choices for each level and the received user inputs of selected choices for each prior level of the decision process.

11. The computer program product of claim 9, further comprising:
computer readable program code configured for receiving user input of a different selected choice at one level;
computer readable program code configured for modifying the display such that the different selected choice is displayed last in the linear arrangement of possible choices at the one level; and
computer readable program code configured for modifying the display such that the possible choices which are dependent on the previously selected choice at the one level are not displayed.

12. The computer program product of claim 11, further comprising:
computer readable program code configured for determining if there are any stored possible choices, at the next lower level from the one level having the different selected choice, which are dependent on the different selected choice; and
computer readable program code configured for, if it is determined that there are stored possible choices, at the next lower level from the one level having the different selected choice, which are dependent on the different selected choice, then modifying the display such that the determined possible choices which are dependent on the different selected choice are displayed in a linear arrangement indented from the linear arrangement of the one level.

13. The computer program product of claim 12, further comprising:
computer readable program code configured for, if it is determined that there are not any stored possible choices, at the next lower level from the one level having the different selected choice, which are dependent on the different selected choice, then prompting the user to input one or more possible choices that are dependent on the different selected choice.

14. The computer program product of claim 9, further comprising:
computer readable program code configured for prompting a user to provide input indicating either (i) agreement or disagreement or (ii) a degree of agreement corresponding to each group of possible choices displayed at each of one or more levels.

15. The computer program product of claim 9, further comprising:
computer readable program code configured for prompting a user to provide input indicating either (i) agreement or disagreement or (ii) a degree of agreement corresponding to each possible choice displayed at each of one or more levels.

16. The computer program product of claim 9, wherein the linear arrangements comprise a top-to-bottom vertical arrangement.

17. A computer-implemented method for modifying a display of a decision tree, comprising:
(a) determining all possible choices at a top level of the decision tree;
(b) determining a selected choice at the top level of the decision tree, the selected choice comprising one of the determined possible choices;
(c) displaying the determined top level possible choices in a linear arrangement with the determined top level selected choice displayed last in the linear arrangement;
(d) determining all possible choices at a next lower level of the decision tree based on the determined selected choice at the prior level, wherein the possible choices at the next lower level do not include choices dependent on non-selected choices at the prior level;
(e) determining a selected choice at the next lower level of the decision tree, the selected choice comprising one of the determined possible choices;
(f) displaying the determined next lower level possible choices in a linear arrangement with the determined next lower level selected choice displayed last in the linear arrangement, wherein the linear arrangement is indented from the linear arrangement of the prior level; and
(g) repeating steps (d)-(f) for each subsequent lower level of the decision tree.

18. The method of claim 17, wherein the linear arrangements comprise a top-to-bottom vertical arrangement.

19. A computer program product for modifying a display of a decision tree, the computer program product comprising a computer readable storage medium having computer readable program code embodied therewith, the computer readable program code comprising:
(a) computer readable program code configured for determining all possible choices at a top level of the decision tree;
(b) computer readable program code configured for determining a selected choice at the top level of the decision tree, the selected choice comprising one of the determined possible choices;
(c) computer readable program code configured for displaying the determined top level possible choices in a linear arrangement with the determined top level selected choice displayed last in the linear arrangement;
(d) computer readable program code configured for determining all possible choices at a next lower level of the decision tree based on the determined selected choice at the prior level, wherein the possible choices at the next lower level do not include choices dependent on non-selected choices at the prior level;
(e) computer readable program code configured for determining a selected choice at the next lower level of the decision tree, the selected choice comprising one of the determined possible choices;
(f) computer readable program code configured for displaying the determined next lower level possible choices in a linear arrangement with the determined next lower level selected choice displayed last in the linear arrangement, wherein the linear arrangement is indented from the linear arrangement of the prior level; and
(g) computer readable program code configured for repeating steps (d)-(f) for each subsequent lower level of the decision tree.

20. The method of claim 19, wherein the linear arrangements comprise a top-to-bottom vertical arrangement.
